(19) United States
(12) Patent Application Publication
(10) Pub. No.: US 2005/0173827 A1
(43) Pub. Date: Aug. 11, 2005

(54) Method for manufacturing patterned products in cementitious agglomerate, particularly tiles, and products obtained thereby

(76) Inventor: Mario Finocchiaro, Giarre (IT)

Correspondence Address: YOUNG & THOMPSON, 745 SOUTH 23RD STREET, 2ND FLOOR, ARLINGTON, VA, 22202, US

(21) Appl. No.: 11/053,889

(22) Filed: Feb. 10, 2005

(30) Foreign Application Priority Data
Feb. 10, 2004 (IT) CT2004A000001

(51) Int. Cl. B28B 3/00

(52) U.S. Cl. 264/138; 264/333

(57) ABSTRACT

Method for manufacturing a product in cementitious agglomerate, with a press and a mold, including the stages of: (a) pouring a single cementitious agglomerate mixture into the mold; (b) bringing the delivery extremity of a liquid delivery tool to immerse itself into the inside of the single mixture poured into the mold and to make it to move therein, delivering a liquid mixture that modifies physical properties of the mixture; and products obtained thereby.

### DISCLOSURE OF THE INVENTION

1. Technical Field

This invention relates to a method for manufacturing patterned products in cementitious agglomerate—such as e.g. steps and tables, and particularly tiles—as well as to a patterned product in cementitious agglomerate, obtained by means of it.

2. Background of the Invention

In the field of the manufacturing of tiles for floors or for coatings in cementitious agglomerate, starting from a mixture, by a press having a mold cavity—and also in all those products, such as e.g. steps, tables and other elements, that can be realized with the same type of agglomerate—whenever it is desired that the chromatic effect of the surface at sight of the product be realized is different from the one spontaneously determined by the employed mixture, or better when it is desired to realize any image on the surface at sight, one is compelled to resort to the employment of a second mixture or a plurality of mixtures different from each other, as well as to the use of suitable partitions—made up of framelets manually profiled in such a way as to reproduce a desired image—which mixtures, once introduced into the inside of the press mold, determine well-defined spaces that allow an operator to fill such spaces manually with a mixture or another mixture having a different color, in such a way that each mixture fills its own space and, once a tile is finished, the profile of the employed partition, and therefore the desired image, is reproduced. This one is the manual manufacturing method which in the specific field of tiles is used to realize the so-called patterned tiles.

However, problems are connected with the above-referred prior art type of manufacturing. In fact, there is the difficulty that operating according to it, a plurality of mixtures have to be prepared, in as many mixers as the mixtures, and there are restrictions connected with the fact that a respective suitable partition has to be arranged for each pattern, as well as the employment of highly skilled labour is necessary.

### OBJECTS, CHARACTERISTICS AND ADVANTAGES OF THE INVENTION

The object of this invention is to solve the above-referred problems.

Such an object is reached according to this invention by mixing a coloring liquid to the cementitious mixture by means of a delivery tool, guided to move in the mixture itself so as to form a pattern therein.

This invention also takes its steps from the consideration that the means taught by it to realize patterned products in cementitious agglomerate, can be applied to create patterns on the same products in cementitious agglomerate, having physical properties modified to improve their use behaviour, such as e.g. hardness, through mixing suitable additives to the cementitious mixture.

Therefore, it is the subject of this invention a method for manufacturing a product in cementitious agglomerate, by means of a press, including a mold,
including the stages of:
(a) pouring a single cementitious agglomerate mixture into said mold;
(b) bringing the delivery extremity of a liquid delivery tool to immerse itself into the inside of said single mixture poured into said mold and to make it to move therein, delivering a liquid mixture that modifies physical properties of said mixture.

It is also the subject of this invention a product in cementitious agglomerate manufactured thereby.

### BRIEF DESCRIPTION OF THE DRAWINGS

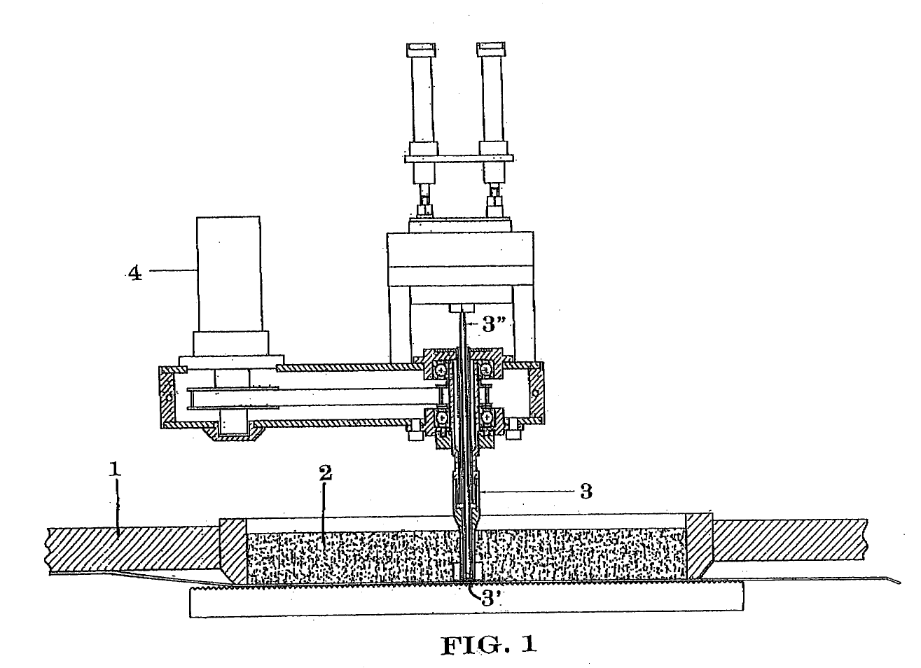

This invention will be fully understood based on the following detailed disclosure of preferred embodiments thereof, only given as a matter of example, absolutely not of restriction, referring to the annexed drawings, wherein:
the only FIG. 1 represents an equipment for realizing the inventive method.

### DETAILED DISCLOSURE OF THE INVENTION

Referring to FIG. 1, in a normal rotary press 1, whereinto a normal, fluid-state mixture dose 2—i.e. the dose of cement, powder, grit and water, already mixed, necessary for forming the nascent product—has been poured, preferably into the mold relevant to a press for manufacturing single-layer materials, i.e. lacking an underlying layer, a delivery tool 3 is made to penetrate into mixture 2, up to skim the bottom of mold 1 with a delivery extremity 3′ thereof. Delivery tool 3 is pierced along a longitudinal axis thereof, where it is crossed by a tubelet 3″. Delivery tool 3 is actuated in motion by a motor 4, preferably a pneumatic motor; delivery tool 3, moving under the actuation of motor 4, determines the mixing of the coloring liquid with the mixture in the mold. Through pipelet 3″ colouring liquid arrives, e.g. water colored with oxides or pigments, that delivery tool 3, moving itself, mixes with fluid mixture 2 already present in the mold. In such a way all the mixture that comes into contact with the delivery extremity 3′ of the delivery tool undergoes the influence of the new color. The colored water can be spread for a thickness of about 1 cm from the bottom of the mold.

Delivery tool 3 is assembled on a three-axes pantograph (not shown in the drawing) controlled electronically, which makes it to follow a preset translation path inside the mixture, so that it realizes a desired pattern there. Along such a path a suitable dispenser (not shown in the drawing) can alternate the color of the colored water, e.g. under electronic control, realizing polychrome patterns. Delivery tool 3, once it has realized an entire programmed path inside mixture 2, is lifted, so that the mold can be rotated. The subsequent stage is pressing the just patterned tile so obtained, after which pressing the tile, bearing a pattern on the face that in the mixture was turned towards the bottom of the mold, is removed from the mold.

Alternately, if the inventive concept is realized operating with a dual-layer—i.e. having an underlayer-press for tiles, the stage pressing stage is preceded by a filling of the mold with the semi-dry mixture of the underlayer.

A variant is to pour into the mold of the press a mixture dose which is more than double of the normal one to obtain a double thickness tile. In this case delivery tool 3 is made to penetrate up to half the depth of the mixture poured into the mold. The subsequent stage in this case too is pressing followed by removal of the so obtained tile, followed by seasoning and cutting, obtaining two patterned tiles. By this variant one has the advantage that the production is doubled and that one has tiles having perfectly specular patterns.

This invention has been disclosed and illustrated referring to specific embodiments thereof, but it is to be expressly understood that variations, additions and/or omissions can be made, without departing from the scope of protection of this invention, which remains restricted only by the annexed claims.

1. Method for manufacturing a product in cementitious agglomerate, by means of a press, including a mold,
characterized in that it includes the stages of:
(a) pouring a single cementitious agglomerate mixture into said mold;
(b) bringing the delivery extremity of a liquid delivery tool to immerse itself into the inside of said single mixture poured into said mold and to make it to move therein, delivering a liquid mixture that modifies physical properties of said mixture.

2. Method according to claim 1, wherein said mixture that modifies physical properties is a dyeing mixture for modifying the color of said cementitious agglomerate so as to form a pattern on a surface of the product.

3. Method according to claim 1, wherein said delivery tool is made to penetrate into said single mixture up to skim the bottom of said mold by said delivery extremity thereof.

4. Method according to claim 1, wherein said delivery tool is made to penetrate into said single mixture up to half the depth of the mixture poured into said mold, and the product obtained thereby is subsequently subjected to cutting.

5. Product in cementitious agglomerate manufactured by the method according to claim 1.

6. Method according to claim 2, wherein said delivery tool is made to penetrate into said single mixture up to skim the bottom of said mold by said delivery extremity thereof.

7. Method according to claim 2, wherein said delivery tool is made to penetrate into said single mixture up to half the depth of the mixture poured into said mold, and the product obtained thereby is subsequently subjected to cutting.
